(19) United States
(12) Patent Application Publication
(10) Pub. No.: US 2026/0155904 A1
(43) Pub. Date: Jun. 4, 2026

(54) Identification of Active and Passive Entities in Wireless Communication System Using Zadoff-Chu Sequences

(71) Applicant: HUAWEI TECHNOLOGIES CO., LTD., Shenzhen (CN)

(72) Inventors: Michel Saideh, Boulogne Billancourt (FR); Mohamed Kamoun, Boulogne Billancourt (FR); Mustapha Amara, Boulogne Billancourt (FR); Melissa Duarte Gelvez, Boulogne Billancourt (FR); Mahdi Shakiba Herfeh, Boulogne Billancourt (FR); Chengjun Shao, Hangzhou (CN)

(73) Assignee: HUAWEI TECHNOLOGIES CO., LTD., Shenzhen (CN)

(21) Appl. No.: 19/465,113

(22) Filed: Jan. 30, 2026

Related U.S. Application Data
(63) Continuation of application No. PCT/EP2023/071166, filed on Jul. 31, 2023.

(51) Int. Cl. H04J 13/00; H04W 72/044

(52) U.S. Cl. CPC H04J 13/0062; H04W 72/0466

(57) ABSTRACT

In a wireless communication system, including transmitter entities, digitally controllable scattering (DCS) entities, a receiver entity, and a control entity, the receiver entity can identify, by respectively transmitting or scattering a signal, which of the transmitter entities and which of the DCS entities contributed to a receive signal received at the receiver entity over one or more direct links and/or one or more indirect links. The identification by the receiver entity is based on the use of Zadoff-Chu (ZC) identities determining ZC sequences, where unique ZC identities are used at the transmitter entities for transmitting signals and at the DCS entities for scattering impinging signals.

### CROSS-REFERENCE TO RELATED APPLICATIONS

This is a continuation of Int'l Patent App. No. PCT/EP2023/071166 filed on Jul. 31, 2023, which is incorporated by reference.

### TECHNICAL FIELD

The present disclosure relates to wireless communications in a wireless communication system. The disclosure provides a transmitter entity, a digitally controllable scattering (DCS) entity, a receiver entity, and a control entity for the wireless communication system. A DCS may be also referred to as a reconfigurable intelligent surface (RIS), an intelligent reflecting surface (IRS), a large intelligent surface (LIS), or a smart repeater. The wireless communication systems can include more than one of each entity. The receiver entity can identify, which of one or more transmitter entities and one or more DCS entities in the wireless communication system contributed to a receive signal, which is received at the receiver entity. The receive entity can also identify over which direct links and indirect links the signals contributing to the receive signal propagated. The identification is possible because of the use of unique Zadoff-Chu (ZC) identities at the transmitter entities, the DCS entities, and the receiver entity, respectively.

### BACKGROUND

Synchronization techniques using primary synchronization signals (PSSs) or secondary synchronization signals (SSSs), for example, in a 4th generation (4G) or fifth generation (5G) wireless communication system, consider the identification of direct links between transmitter entities and receiver entities, respectively. However, these techniques do not consider the identification of indirect links, i.e., links including scattering at one or more DCS entities, which contribute to the receive signal at the receiver entity. In other words, only the contributions of the transmitter entities to the receive signal can be identified by the receiver entity, while contributions of DCS entities cannot be identified.

### SUMMARY

The present disclosure and its solutions are based further on the following considerations.

An exemplary synchronization technique in other approaches of a 4G system uses ZC sequences, wherein a k^{th} sample of a prime length (N_{ZC}) ZC sequence with uᵢ identity may be written as follows

$${z}_{{u}_{i}} ( k ) = {e}^{- \frac{j π {u}_{i} k ( k + 1 )}{{N}_{ZC}}}$$

A ZC identity is assigned to each transmitter entity, e.g., to each base station (BS), such that during the synchronization each BS transmits a different ZC based signal (short “ZC signal”) as described in the following.

(1) For an orthogonal frequency-division multiplexing (OFDM) waveform:
a. The transmitting entity constructs an OFDM symbol by mapping a conjugate

$$( {z}_{{u}_{i} ( k )}^{*} )$$

of the created ZC sequence into a N_{ZC} length inverse discrete Fourier transform (IDFT) input:

$$x ( m ) = {\sum }_{k = 0}^{{N}_{ZC} - 1} {e}^{\frac{j 2 π km}{{N}_{ZC}}} {z}_{{u}_{i} ( k )}^{*}$$

b. The IDFT transform of the conjugate of a ZC sequence with identity uᵢ results in another ZC sequence with a new identity

$${u}_{i}^{- 1}$$

and a frequency shift that could be written after some manipulations as follows:

$$x ( m ) = {z}_{{u}_{i}^{- 1}} ( m ) {e}^{- \frac{j 2 π}{{N}_{ZC}} ( 1 - {u}_{i}^{- 1} ) {2}^{- 1} m} {x}^{*} ( 0 )$$

where 2⁻¹ is the multiplicative inverse of 2 modulo N_{ZC} and u⁻¹ is the multiplicative inverse of u modulo N_{ZC}. This means that the OFDM signal of a ZC sequence with uᵢ identity is another ZC sequence with root

$${u}_{i}^{- 1}$$

that is frequency shifted by

$${e}^{- \frac{j 2 π}{{N}_{ZC}} ( 1 - {u}_{i}^{- 1} ) {2}^{- 1} m}$$

and scaled by x*(0).

(2) For a cyclic prefix (CP) OFDM waveform:
a. The transmitting entity constructs a CP-OFDM symbol by mapping the conjugate of the created ZC sequence into the N_{ZC} length IDFT input:

$$x ( m ) = \{ \begin{matrix}{\sum }_{k = 0}^{{N}_{ZC} - 1} {e}^{\frac{j 2 π km}{{N}_{ZC}}} {z}_{{u}_{i} ( k )}^{*} & if & {N}_{CP} \leq m < {N}_{ZC} + {N}_{CP} \\ {\sum }_{k = 0}^{{N}_{ZC} - 1} {e}^{\frac{j 2 π k ( {N}_{ZC} - {N}_{CP} + m )}{{N}_{ZC}}} {z}_{{u}_{i} ( k )}^{*} & if & 0 \leq m < {N}_{CP}\end{matrix}$$

The CP part represents copying the last N_{CP} samples of the OFDM symbol to the beginning of the OFDM symbol. Hence, the CP-OFDM symbol of a N_{ZC} ZC sequence with identity uᵢ will result in a new ZC sequence with

$${u}_{i}^{- 1}$$

identity that is scaled and frequency shifted as follows:

$$x ( m ) = \{ \begin{matrix}{z}_{{u}_{i}^{- 1}} ( m ) {e}^{- \frac{j 2 π}{{N}_{ZC}} ( 1 - {u}_{i}^{- 1} ) {2}^{- 1} m} {x}^{*} ( 0 ) & if & {N}_{CP} \leq m < {N}_{ZC} + {N}_{CP} \\ \begin{matrix}{z}_{{u}_{i}^{- 1}} ( {N}_{ZC} - {N}_{CP} + m ) \\ {e}^{- \frac{j 2 π}{{N}_{ZC}} ( 1 - {u}_{i}^{- 1} ) {2}^{- 1} ( {N}_{ZC} - {N}_{CP} + m )} {x}^{*} ( 0 )\end{matrix} & if & 0 \leq m < {N}_{CP}\end{matrix}$$

As a result of the above signal design at the BSs, the signal received at the receiver entity (e.g., and end-user mobile or terminal device) from each transmitter entity (e.g., BS) is a ZC based sequence. By doing a decorrelation based on the known used ZC sequences, the receiver entity can identify the transmitter entities that contribute with most energy to its received signal.

However, this approach, where ZC sequences are only assigned to the transmitter entities and not to the DCS entities, does not allow the receiver entity to identify the DCS nodes that contribute to an indirect link.

Moreover, solutions in other approaches do not consider guaranteeing signal orthogonality after multiple DCS bounces (a DCS bounce being a scattering of the signal at a DCS entity). When a signal travels from a transmitter entity to a receiver entity after being scattered by multiple DCS entities, the signal experiences multiple DCS bounces. The solutions in other approaches cannot be used to identify the DCS entities that contribute to create a link from the transmitter entity to the receiver entity, when the number of contributing DCS entities is more than one.

In view of the above, an objective of this disclosure is to provide the receiver entity with the capability to identify different direct links and indirect links that a signal transmitted by at least one transmitter entity undergoes before reaching the receiver entity. An objective is also to identify one or more transmitter entities and zero, one or more DCS entities, that contribute to the receive signal at the receiver entity. Another objective is to use the knowledge about the above identification in post-processing at the receiver entity, to obtain a Timing Advance (TA) and signal to interference and/or noise ratio (SINR) of each identified link, and/or to perform a localization of the receiver entity.

These and other objectives are achieved by the solutions in this disclosure as described in the independent claims. Advantageous implementations are further defined in the dependent claims.

A first aspect of this disclosure provides a control entity for a wireless communication system, the control entity being configured to: obtain a first set of ZC identities, wherein the ZC identities of the first set are designed for being individually allocated to one or more transmitter entities in the wireless communication system; and/or obtain a second set of ZC identities, wherein the ZC identities of the second set are designed for being individually allocated to one or more digitally controllable scattering, DCS, entities in the wireless communication system; and/or obtain a third set of ZC identities, wherein each ZC identity of the third set is associated with a different direct link from one of the one or more transmitter entities to a receiver entity in the wireless communication system than the other ZC identities of the third set; and/or obtain a fourth set of ZC identities, wherein each ZC identity of the fourth set is associated with a different indirect link from one of the one or more transmitter entities via at least one of the one or more DCS entities to the receiver entity than the other ZC entities of the fourth set; wherein the ZC identities of the third set are related according to a one-to-one function to the ZC identities of the first set; wherein each ZC identity is configured to determine a unique ZC sequence; and wherein the third set and the fourth set have no ZC identity in common.

The sets of ZC identities, which are obtained by the control entity of the first aspect, may be used at the one or more transmitter entities to transmit signals, respectively, may be used at the one or more DCS entities to scatter impinging signals, respectively, and may further be used at a receiver entity to perform identification. For example, to identify in a receive signal, different direct links and indirect links that the transmission signal(s) transmitted by the one or more transmitter entities followed, before reaching the receiver entity. As another example, to identify, which transmitter entity sent a transmission signal, and by which zero or more DCS entities the one or more transmission signals were scattered before reaching the receiver entity.

In an implementation form of the first aspect, the control entity is configured to: obtain one or more subsets of ZC identities, the union of which is a subset of the fourth set; wherein a ZC identity of a respective subset is associated with an indirect link from one of the one or more transmitter entities via a respective number of the one or more DCS entities to the receiver entity, wherein the respective number is one or larger and is different for the subsets.

Thus, it may be possible for the receiver entity to determine the DCS entities by which a transmission signal of a transmitter entity was scattered, before reaching the receiver entity.

In an implementation form of the first aspect, the control entity is further configured to construct all the sets of ZC identities.

In an implementation form of the first aspect, the control entity is further configured to: signal a different ZC identity of the ZC identities from the first or third set to each of the one or more transmitter entities; and signal a different ZC identity of the ZC identities from the second set to each of the one or more DCS entities.

That is, each transmitter entity may be provided by the control entity with a different ZC identity from the first set, so that a receiver entity can distinguish the transmission signals from different transmitter entities.

In an implementation form of the first aspect, the control entity is further configured to signal the first set or the third set to the receiver entity; and signal the second set or the fourth set to the receiver entity.

Thus, the receiver entity is provided with the knowledge of the ZC identities in these sets, and may thus use them to identify transmitter entities and DCS entities when receiving receive signals.

In an implementation form of the first aspect, the control entity is configured to signal a number of subsets and/or the number of subsets in the fourth set to the receiver entity.

In an implementation form of the first aspect, the control entity is further configured to signal a ZC sequence length to the receiver entity, wherein the ZC sequence length is the same for each unique ZC sequence.

A second aspect of this disclosure provides a DCS entity for a wireless communication system, the DCS entity being configured to: scatter a signal impinging on the DCS entity; wherein the scattering by the DCS entity is based on a unique ZC sequence that is determined by a ZC identity, with which the DCS entity is configured.

Each DCS entity in the wireless communication system may be provided with a different ZC identity, so that a receiver entity can distinguish the signals scattered by different DCS entities.

In an implementation form of the second aspect, the signal impinging on the DCS entity includes one or more ZC signals that are respectively based on one or more transmission signals originating respectively from one or more transmitter entities and being respectively scattered by zero or one or more other DCS entities in the wireless communication system; and the one or more ZC signals contain one or more ZC sequences.

That is, the DCS entity may scatter one or more transmission signals from one or more transmitter entities, after the one or more transmission signals have been respectively scattered by either zero, one or more DCS entities in the wireless communication system.

In an implementation form of the second aspect, the DCS entity comprises a plurality of scattering elements, wherein each scattering element has a controllable phase shift; and a DCS controller configured to control the scattering of the signal impinging onto the DCS entity by setting a phase shift configuration for the plurality of scattering elements based on the ZC identity.

In an implementation form of the second aspect, the phase shift configuration comprises a first phase shift configuration part and a second phase shift configuration part; and the DCS controller is configured to set the first phase shift configuration part as a function of the ZC identity, and to set the second phase shift configuration part independent of the ZC identity.

Accordingly, the DCS entity is configured to set the first phase shift configuration part based on the ZC identity, which may lead to the scattering of the impinging signal based on the ZC identity.

In an implementation form of the second aspect, the DCS entity is further configured to receive a signaling from a control plane entity; wherein the signaling includes the ZC identity.

In this way, the DCS entity can be provided and/or configured with the ZC identity.

In an implementation form of the second aspect, the scattered signal produced by scattering the signal impinging on the DCS entity is based on the one or more ZC sequences, which the one or more impinging ZC signals contain, and is based further on the unique ZC sequence that is determined by the ZC identity, with which the DCS entity is configured, wherein that ZC identity is included in the second set.

Thus, a receiver entity may identify, from which of the one or more transmitter entities the scattered signal stems, and by which one or more DCS entities it was scattered before reaching the receiver entity.

A third aspect of this disclosure provides a receiver entity for a wireless communication system, the receiver entity being configured to: obtain a receive signal that includes one or more ZC signals that are respectively based on one or more transmission signals respectively originating from one or more transmitter entities and respectively scattered by zero or one or more DCS entities in the wireless communication system; process the receive signal based on a plurality of unique ZC sequences that are respectively determined by a plurality of ZC identities, with which the receiver entity is configured, e.g., which is provided to the receiver entity; and determine, based on the result of the processing, one or more of the ZC sequences, on which the one or more ZC signals in the receive signal are based.

The receiver entity may identify, in the receive signal, different direct links and indirect links that the transmission signal(s) transmitted by the one or more transmitter entities followed, before reaching the receiver entity. The receiver entity may also identify by using the ZC identities it is provided with, which one or more transmitter entities sent a transmission signal, and by which zero or one or more DCS entities the transmission signal was scattered before reaching the receiver entity.

In an implementation form of the third aspect, to process the receive signal, the receiver entity is configured to: correlate the receive signal with each of a plurality of correlating signals, wherein each correlating signal is based on one of the unique ZC sequences that is determined by one of the ZC identities, with which the receiver entity is configured, e.g., with which the receiver entity has been provided.

The above describes an example, how the receiver entity can efficiently identify the one or more ZC signals in the receive signal.

In an implementation form of the third aspect, the receiver entity is further configured to determine, for each of the determined one or more ZC sequences, based on the one or more ZC identities associated with the determined one or more ZC sequences, the transmitter entity from which the determined ZC sequence originated from and/or the zero or one or more DCS entities via which the determined ZC sequence propagated.

Thus, the receiver entity can identify, for each ZC signal, the originating transmitter entity and the zero or one or more DCS entities that formed the link from said originating transmitter entity to the receiver entity.

In an implementation form of the third aspect, the receiver entity is further configured to generate the plurality of correlating signals based on the plurality of ZC identities, with which the receiver entity is configured.

In an implementation form of the third aspect, the plurality of ZC identities, with which the receiver entity is configured, include a first set of ZC identities, wherein each of the one or more transmitter entities is configured with one of the ZC identities of the first set; and/or a second set of ZC identities, wherein each of the one or more DCS entities is configured with one of the ZC identities of the second set; and/or the plurality of ZC identities, with which the receiver entity is configured, include a third set of ZC identities, wherein each direct link from one of the one or more transmitter entities to the receiver entity is associated with one ZC identity of the third set; and/or a fourth set of ZC identities, wherein each indirect link from one of the one or more transmitter entities and via at least one of the one or more DCS entities to the receiver entity is associated with one ZC identity of the fourth set.

In an implementation form of the third aspect, the receiver entity is further configured to receive a signaling from a control entity of the wireless communication system; wherein the signaling comprises the first set or the third set; and wherein the signaling comprises the second set or the fourth set.

In this way, the receiver entity can be provided and/or configured with the ZC identities of the respective sets.

In an implementation form of the third aspect, the receiver entity is further configured to determine a timing advance (TA) based on: the determined one or more ZC sequences, on which the one or more ZC signals in the receive signal are based; or information on which of the one or more transmission signals of the one or more transmitter entities the one or more ZC signals in the receive signal are based and by which of the zero or one or more DCS entities the one or more transmission signals were respectively scattered.

In an implementation form of the third aspect, the receiver entity is further configured to determine a TA for each of one or more direct links and/or one or more indirect links from the one of the one or more transmitter entities to the receiver entity; and generate a one-to-one relationship between the one or more timing advances and the one or more links.

The receiver entity may obtain the TA and also the SINR of each identified link, and may perform a localization procedure based thereon.

A fourth aspect of this disclosure provides a wireless communication system comprising at least a transmitter entity, a receiver entity, and a DCS entity; wherein the transmitter entity is configured with a first ZC identity; wherein the DCS entity is configured with a second ZC identity; and wherein the receiver entity is provided with a plurality of ZC identities; wherein the transmitter entity is configured to generate a signal based on the first ZC identity, wherein the signal is based on a ZC sequence determined by the first ZC identity; wherein the DCS entity is configured to scatter, based on the second ZC identity, an impinging signal, wherein the impinging signal includes the signal generated by the transmitter entity based on the first ZC identity, and wherein the scattered signal includes a signal containing a unique ZC sequence that is based on the first ZC identity and the second ZC identity; wherein the receiver entity is configured to process the receive signal based on a plurality of unique ZC sequence determined by the plurality of ZC identities, with which the receiver entity is provided; and wherein the receiver entity is configured to determine, for each ZC sequence identified by the processing, that the identified ZC sequence is based on the first ZC identity or is based on the first ZC identity and the second ZC identity.

In an implementation form of the fourth aspect, the wireless communication system further comprises a control entity; wherein the control entity is configured to provide the first ZC identity to the transmitter entity, the second ZC identity to the DCS entity, and the plurality of ZC identities to the receiver entity.

The wireless communication system may combine the advantages described above for the control entity of the first aspect, DCS entity of the second aspect, and receiver entity of the third aspect.

A fifth aspect of this disclosure provides a method for a wireless communication system, the method being performed by a control entity and comprising: obtaining a first set of Zadoff-Chu, ZC, identities, wherein the ZC identities of the first set are designed for being individually allocated to one or more transmitter entities in the wireless communication system; and/or obtaining a second set of ZC identities, wherein the ZC identities of the second set are designed for being individually allocated to one or more digitally controllable scattering, DCS, entities in the wireless communication system; and/or obtaining a third set of ZC identities, wherein each ZC identity of the third set is associated with a different direct link from one of the one or more transmitter entities to a receiver entity in the wireless communication system than the other ZC identities of the third set; and/or obtaining a fourth set of ZC identities, wherein each ZC identity of the fourth set is associated with a different indirect link from one of the one or more transmitter entities via at least one of the one or more DCS entities to the receiver entity than the other ZC entities of the fourth set; wherein the ZC identities of the third set are related according to a one-to-one function to the ZC identities of the first set; wherein each ZC identity is configured to determine a unique ZC sequence; and wherein the third set and the fourth set have no ZC identity in common.

The method of the fifth aspect may have further implementation forms corresponding respectively to the implementation forms of the control entity of the first aspect. The method of the fifth aspect and its implementation forms achieve the same advantages as the control entity of the first aspect and its respective implementation forms.

A sixth aspect of this disclosure provides a method for a wireless communication system, the method being performed by a DCS entity and comprising: scattering a signal impinging on the DCS entity; wherein the scattering is based on a unique ZC sequence that is determined by a ZC identity, with which the DCS entity is configured.

The method of the sixth aspect may have further implementation forms corresponding respectively to the implementation forms of the DCS entity of the second aspect. The method of the sixth aspect and its implementation forms achieve the same advantages as the DCS entity of the second aspect and its respective implementation forms.

A seventh aspect of this disclosure provides a method for a wireless communication system, the method being performed by a receiver entity and comprising: obtaining a receive signal that includes one or more ZC signals that are respectively based on one or more transmission signals respectively originating from one or more transmitter entities and respectively scattered by zero or one or more DCS entities in the wireless communication system, i.e., in a propagation environment; processing the receive signal based on a plurality of unique ZC sequences that are respectively determined by a plurality of ZC identities, with which the receiver entity is configured; and determining, based on the result of the processing, one or more of the ZC sequences, on which the one or more ZC signals in the receive signal are based.

The method of the seventh aspect may have further implementation forms corresponding respectively to the implementation forms of the receiver entity of the third aspect. The method of the seventh aspect and its implementation forms achieve the same advantages as the receiver entity of the third aspect and its respective implementation forms.

An eighth aspect of this disclosure provides a method for a wireless communication system comprising at least a transmitter entity, a receiver entity, and a DCS entity; wherein the transmitter entity is provided with a first ZC identity; wherein the DCS entity is provided with a second ZC identity; and wherein the receiver entity is provided with a plurality of ZC identities; and wherein the method comprises: generating, by the transmitter entity, a signal based on the first ZC identity, wherein the signal is based on a unique ZC sequence determined by the first ZC identity; scattering, by the DCS entity based on the second ZC identity, an impinging signal, wherein the impinging signal includes the signal generated by the transmitter entity based on the first ZC entity, and wherein the scattered signal includes a signal containing a unique ZC sequence that is based on the first ZC identity and the second ZC identity; receiving, by the receiver entity, the signal generated by the transmitter entity and the scattered signal of the DCS entity as a receive signal; processing, by the receiver entity, the receive signal based on a plurality of unique ZC sequence determined by the plurality of ZC identities, with which the receiver entity is provided; and determining, by the receiver entity, for each ZC sequence identified by the processing, that the identified ZC sequence is based on the first ZC identity or is based on the first ZC identity and the second ZC identity.

The method of the eighth aspect may have further implementation forms corresponding respectively to the implementation forms of the wireless communication system of the fourth aspect. The method of the eighth aspect and its implementation forms achieve the same advantages as the wireless communication system of the fourth aspect and its respective implementation forms.

A ninth aspect of this disclosure provides a computer program comprising instructions which, when the program is executed by a computer, cause the computer to perform the method according to one of the fifths to eighth aspect.

In summary of the above-mentioned aspects and implementation forms, this disclosure provides a receiver entity with identification capability of the direct links and indirect links (backscattered by one or more DCS entities) that a transmission signal of a transmitter entity undergoes, before reaching the receiver entity. The disclosure is based on designing and distributing ZC identities among the transmitter entities, the DCS entities, and the receiver entity, in order to guarantee a unique ZC identity for each transmitter entity and DCS entity and/or for each considered direct and indirect link. This identification capability at the receiver entity may be exploited to achieve different objectives and applications such as measurements related to different received paths (e.g., TA, SINR) and localization.

The solution of this disclosure using the ZC identity distribution for signal transmission at transmitter entities and DCS scattering also allows identifying contributions of indirect links for the case where the indirect links result from more than one DCS entity (scattering) bounce.

The solutions of this disclosure are applicable to a scenario with multiple transmitter entities and multiple DCS entities in the propagation environment and/or the wireless communication system, wherein a transmitted signal may reach the receiver entity after passing through different direct and indirect links.

A direct link may be defined as the trajectories the transmission signal emitted from a transmitter entity undergoes to reach the end-user without being reflected by any DCS entity. An indirect or backscattered link may be defined as the trajectory or trajectories the transmission signal emitted from a transmitter entity undergoes to reach the receiver entity after being bounced (scattered) by one or more DCS entities.

A DCS entity may contain M scattering elements with each scattering element having a controllable phase shift. Since the scattering elements do not have to be connected to RF chains then DCS entity may be considered as a passive node, but is not limited thereto in this disclosure. This in contrast to a transmitter entity, which may have active RF chains and hence is considered as active node in this disclosure.

It has to be noted that all devices, elements, units and means described in the present disclosure could be implemented in the software or hardware elements or any kind of combination thereof. All steps which are performed by the various entities described in the present disclosure as well as the functionalities described to be performed by the various entities are intended to mean that the respective entity is adapted to or configured to perform the respective steps and functionalities.

Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms will be explained in the following description of specific embodiments in relation to the enclosed drawings, in which

FIG. 1 shows a wireless communication system including a control entity according to this disclosure.

FIG. 2A shows a DCS entity according to this disclosure, and FIG. 2B shows a wireless communication system including a receiver entity according to this disclosure.

FIG. 3 shows an exemplary allocation of ZC identities in a wireless communication system according to this disclosure.

FIG. 4 illustrates links between transmitter, DCS, and receiver entities in a wireless communication system according to this disclosure.

FIG. 5 shows an exemplary flow chart for a dynamic ZC identity set construction process.

FIG. 6 shows an example of a wireless communication system according to this disclosure.

FIG. 7 shows a method according to this disclosure for a control entity.

FIG. 8 shows a method according to this disclosure for a DCS entity

FIG. 9 shows a method according to this disclosure for a receiver entity.

FIG. 10 shows a method according to this disclosure for a wireless communication system.

### DETAILED DESCRIPTION OF EMBODIMENTS

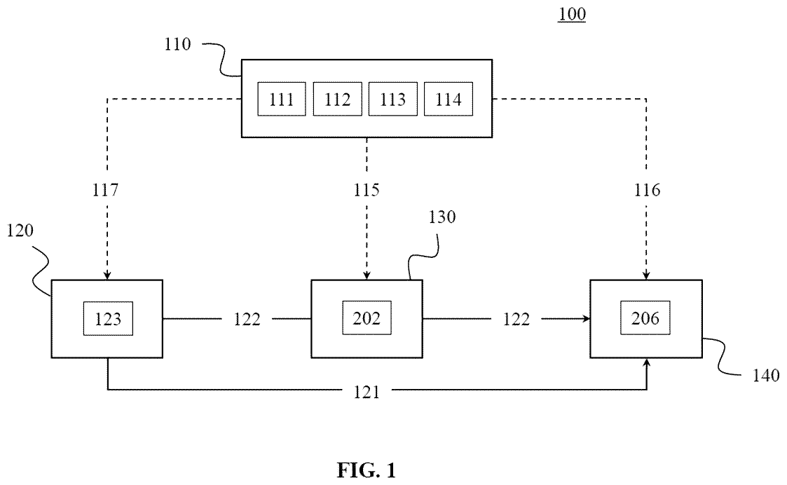

FIG. 1 shows a wireless communication system 100 according to this disclosure. As illustrated, the wireless communication system 100 comprises at least a control entity 110, a transmitter entity 120, a DCS entity 130, and a receiver entity 140. Notably, the wireless communication system 100 can of course comprise more than one transmitter entity 120, more than one DCS entity 130, and more than one receiver entity 140. The wireless communication system 100 may be a wireless network, for example, a cellular network like a 4G or 5G network or WiFi network or AdHoc network. The one or more transmitter entities 120 may be network devices like communication nodes or BSs or the like, and the one or more receiver entities 140 may be communication nodes or end-user devices like mobile phones, terminal devices, or other user equipment (UE).

The control entity 110 is configured to obtain, at least one of a first set 111 of ZC identities, a second set 112 of ZC identities, a third set 113 of ZC identities, and a fourth set 114 of ZC identities. For instance, the control entity 100 can be configured to design and/or construct the first, second, third and fourth set of ZC identities. Each ZC identity in any set 111, 112, 113, 114 is configured to determine a unique ZC sequence. The ZC identities of the third set 113 are related according to a one-to-one function to the ZC identities of the first set 111, and the third set 113 and the fourth set 114 have no ZC identity in common.

The ZC identities of the first set 111 are obtained and designed for being individually provided to the one or more transmitter entities 120 in the wireless communication system 100, while the ZC identities of the second set 112 are obtained and designed for being individually provided to one or more DCS entities 130 in the wireless communication system 100. For example, the control entity 100 may be configured to provide a signaling 117 to the transmitter entity 120, in order to signal one ZC identity 123 from the first set 111 to the transmitter entity 120, or may generally signal a different ZC identity from the first set 111 to each of the one or more transmitter entities 120 in the wireless communication system 100. The control entity 110 may alternatively signal the third set 113 instead of the first set 111 to the transmitter entity 120. As another example, the control entity 100 may be configured to provide a signaling 115 to the DCS entity 130, in order to signal one ZC identity 202 from the second set 112 to the DCS entity 130, or may generally signal a different ZC identity from the second set 112 to each of the one or more DCS entities 130 in the wireless communication system 100. However, the transmitter entities 120 and DCS entities 130 could also obtain the respective ZC identities in a different manner, for instance, by configuration.

Each ZC identity of the third set 113 is associated with a different direct link 121, from one of the one or more transmitter entities 120 to a receiver entity 140 in the wireless communication system 100, than the other ZC identities of the third set 113. For example, a direct link 121 may exist between the transmitter entity 120 and the receiver entity 140 shown in FIG. 1, and may be associated with one of the ZC identities from the third set 113. Each ZC identity of the fourth set 114 is associated with a different indirect link 122, from one of the one or more transmitter entities 120 via at least one of the one or more DCS entities 130 to the receiver entity 140, than the other ZC entities of the fourth set 114. For example, an indirect link 122 may exist between the transmitter entity 120 and the receiver entity 140 via the DCS entity 130 shown in FIG. 1, and may be associated with one of the ZC identities from the fourth set 114. For example, the control entity 100 may be configured to provide a signaling 116 to the receiver entity 140, in order to signal the third set 113 and the fourth set 114 to the receiver entity 140. The control entity 110 may alternatively signal the first set 111 instead of the third set 113 and/or the second set 112 instead of the fourth set 114 to the receiver entity 140.

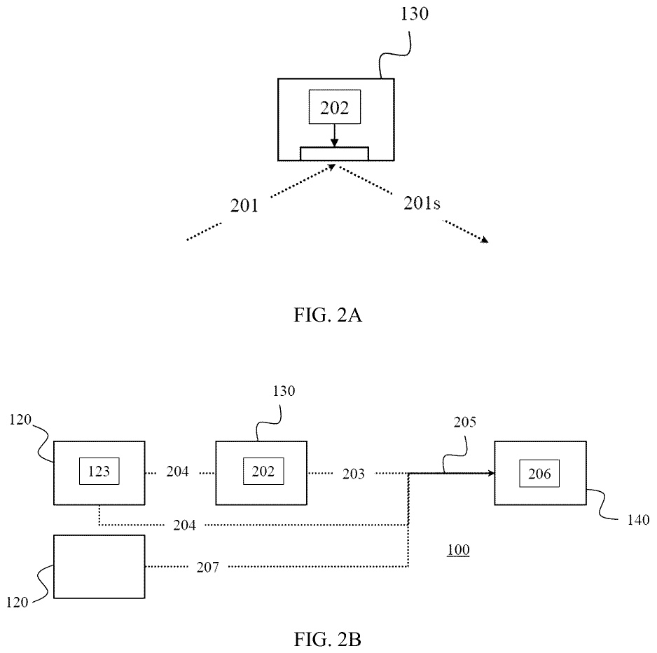

FIG. 2A shows a DCS entity 130 according to this disclosure in more detail. The DCS entity 130 is generally configured to scatter a signal 201 that impinges onto the DCS entity 130. If the DCS entity 130 is the one shown in FIG. 1 or FIG. 2B, the impinging signal 201 may be the transmission signal 204 of the transmitter entity 120. The DCS entity 130 of FIG. 2A could, however, also be another DCS entity 130 in the wireless communication system 100, and the impinging signal 201 may arrive from another DCS entity 130 in the wireless communications system 100. After scattering, the signal 201 is denoted as scattered signal 201s. The signal 201 and the scattered signal 201s may respectively be the signal 122 in FIG. 1.

The DCS entity 130 is configured to scatter the impinging signal 201 based on a unique ZC sequence that is determined by a ZC identity 202, with which the DCS entity 130 is configured. This generates the scattered signal 201s. For example, the DCS entity may have received the signaling 115 from the control entity 110, wherein the signaling 115 includes the ZC identity 202.

FIG. 2B shows a receiver entity 140 according to this disclosure in more detail 140. The receiver entity 140 may be the one shown in FIG. 1. The receiver entity 140 is configured to obtain a receive signal 205, which includes one or more ZC signals 203, 204, 207. The ZC signals are respectively based on one or more transmission signals 204, 207 respectively originating from one or more transmitter entities 120 (two transmitter entities 120 in FIG. 2B) and respectively scattered by zero or one or more DCS entities 130 in the wireless communication system 100 (in FIG. 2B, one DCS entity 130 scatters the transmission signal 204 of one of the two transmitter entities 120). That is, the transmission signals 204 and 207 are ZC signal, as they are transmitted based on the respective unique ZC identities at the transmitter entities 120. The scattered signal 203, which is based on the transmission signal 204, is a ZC signal as well (as it is scattered based on a unique ZC identity 202 configured at the DCS entity 130). That is, the transmission signal 204 could be received by the receiver entity 140 as the scattered signal 203. Further, the transmission signal 204 could be received by the receiver entity 140 without scattering at a DCS entity 130. Another transmission signal 207 could be received by the receiver entity 140 from another transmitter entity 120 as shown in FIG. 2B.

In any case, the receiver entity 140 is configured to process the receive signal 205 based on a plurality of unique ZC sequences that are respectively determined by a plurality of ZC identities 206, with which the receiver entity 140 is provided (e.g., those of the third set 113 and fourth set 114, or the first set 111 and the second set 112). The receiver entity 140 is further configured to determine, based on the result of the processing, one or more of the ZC sequences, on which the one or more ZC signals 203, 204, 207 in the receive signal 205 are based.

The wireless communication system 100 of FIG. 1 may comprise at least one of the transmitter entities 120 of FIG. 2B, the DCS entity of FIG. 2A, and the receiver entity 140 of FIG. 2B. As shown in FIG. 1, the transmitter entity 120 may be provided or configured with the ZC identity 123, the DCS entity 130 may be provided or configured with the ZC identity 202, and the receiver entity 140 may be provided or configured with the plurality of ZC identities 206.

The transmitter entity 120 is configured to generate the transmission signal 204 based on the first ZC identity 123, wherein particularly the transmission signal 204 is based on a unique ZC sequence determined by the ZC identity 123. The DCS entity 130 is configured to scatter the impinging signal, which includes the transmission signal 204 generated by the transmitter entity 120, based on the ZC identity 202. The scattering is based on the ZC identity 202. The scattered signal 203 accordingly includes a signal containing a unique ZC sequence that is based on the ZC identity 123 and the ZC identity 202. The receiver entity 140 is configured to receive, together as the receive signal 205, the transmission signal 204 generated by the transmitter entity 120 over the direct link 121 when the gain of the direct link 121 is larger than a certain threshold, and to receive the scattered signal 203 of the DCS entity 130 over the indirect link 122 when the gain of the indirect link 122 is above a certain threshold.

The receiver entity 140 is then configured to process the receive signal 205 based on the plurality of unique ZC sequences determined by the plurality of ZC identities 206, and to determine, for each ZC sequence identified by the processing, that the identified ZC sequence is based on the ZC identity 123 or is based on the ZC identity 123 and the ZC identity 202. In this way, the receiver entity 140 can identify the entities 120 that are involved in signal transmission and the DCS entities 130 that are involved in signal scattering, and/or the links over which the transmission signal is received including links with zero, one, or more bounces.

The entities 120, 130, 140 may respectively comprise a processor or processing circuitry (not shown) configured to perform, conduct or initiate the various operations of the respective entity 120, 130, 140 described herein. The processing circuitry may comprise hardware and/or the processing circuitry may be controlled by software. The hardware may comprise analog circuitry or digital circuitry, or both analog and digital circuitry. The digital circuitry may comprise components such as application-specific integrated circuits (ASICs), field-programmable arrays (FPGAs), digital signal processors (DSPs), or multi-purpose processors. The entities 120, 130, 140 may respectively further comprise memory circuitry, which stores one or more instruction(s) that can be executed by the processor or by the processing circuitry, in particular under control of the software. For instance, the memory circuitry may comprise a non-transitory storage medium storing executable software code which, when executed by the processor or the processing circuitry, causes the various operations of the respective entity 120, 130, 140 to be performed. In one embodiment, the processing circuitry comprises one or more processors and a non-transitory memory connected to the one or more processors. The non-transitory memory may carry executable program code which, when executed by the one or more processors, causes the respective entity 120, 130, 140 to perform, conduct or initiate the operations or methods described herein.

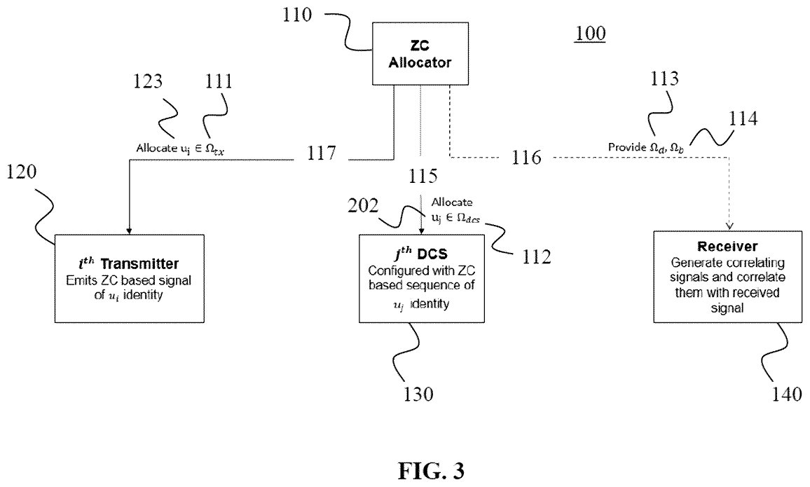

FIG. 3 shows an example of a wireless communication system 100, which bases on the wireless communication system 100 shown in FIG. 1. Same elements are labelled with the same reference signs and may function likewise. In FIG. 3, the control unit 110 is referred to as “ZC allocator”, the transmitter entity 120 as the “i^{th} Transmitter”, the DCS entity 130 as the j^{th} DCS″, and the receiver entity 140 as “Receiver”. In particular, FIG. 3 visualizes the following steps, which may be implemented in the wireless communication system 100.

A first step relates to the control entity 110. The control entity 110 can design and allocate the ZC identity sets 111, 112, 113, 114 and parameters. In the first step, the following may be determined jointly by the control entity 110:
N_{ZC}: The length of the ZC sequence(s).
Ω_{d}: The set (third set 113) of N_{d} ZC identities that could be allocated to the direct links 121. This may be equivalent to designing the Ωₜₓ set (first set 111), which contains the
Nₜₓ identities that could be allocated to the transmitter entities 120. This equivalence is due to the one to one relation between Ωₜₓ and Ω_{d}.
Ω_{dcs}: Specifies the N_{dcs} ZC identities (of the second set 112) that could be allocated to the DCS entities 130.
Ω_{b,l}: Specifies the N_{b,l} ZC identities (subsets of the fourth set 114) that could be allocated to the indirect links 122 with l DCS bounces.
Ω_{b}: Specifies the N_{b} ZC identities (of the fourth set 114) that could be allocated to the overall indirect links 122, where

$${Ω}_{b} = {⋃}_{l = 1}^{γ} {Ω}_{b , l} \qquad Eq . 1$$

Thereby, the parameter γ denotes the maximum number of DCS bounces that an indirect link 122 can contain, while still being uniquely identifiable.

A second step relates to the transmitter entity 120, which generates a ZC sequence based on its ZC identity, and emits the corresponding modulated symbol(s) as transmission signal.

A third step relates to the DCS entity 130 and the design of the DCS phase configuration vector v(m)—for the scattering elements of the DCS entity 130, where

$$v ( m ) = {e}^{j θ} {e}^{j ϕ ( m )}$$

This vector corresponds to a phase shift configuration, which comprises two phase shift configuration parts. The first part is called a DCS common phasor (e^{jφ(m)}∈ [symbol] ^{1×1}). It is designed based on the allocated ZC identity to transform the incident ZC based signal into another ZC sequence with new identity, so that it could be identified by the receiver entity 140. The second part is called a DCS element-specific phasor (e^{jθ}∈ [symbol] ^{M×1}), which is an available degree of freedom that could be exploited to achieve different objectives.

A fourth step relates to the receiver entity 140, e.g., the end-user device, which may correlate the overall receive signal 205 with pre-generated correlating signals, which correspond to all ZC sequences within Ω_{d} ∪Ω_{b}, in order to identify the existing direct links 121 and indirect links 122. Detected peaks could go through one or more different post-processing procedures depending on the desired objective and/or application such as measurements (e.g., TA, SINR), and localization.

The proposed solution of this disclosure may solve the problem of identifying, for each of a plurality of received links 121, 122 perceived by any of a plurality of receiver entities 140, all the active transmitter entities 120 and passive DCS entities 130 that participate as contributors to create the paths that define a link 121, 122. A link 121, 122 can be represented by a sequence of its active contributor (transmitter entity 120) or active and passive contributors (transmitter entity 120 and DCS entity 130). Several representations can be present in a link 121, 122 that would correspond to different orders of the sequences i.e. the bounces at the DCS entities 130, wherein here the sequences are those of its active contributor or active and passive contributors.

The solution of this disclosure includes a joint design of transmission signal(s) 204, 207 and DCS common phasor based on ZC sequences. The transmission signal 204, 207 sent by each transmitter entity 120 is based on a ZC sequence and the DCS common phasor for each DCS entity 130 is also based on a ZC sequence, such that when the transmission signal 204, 207 is scattered by a DCS entity 130, the resulting scattered signal 203 is also a ZC based signal (ZC signal). The constructed ZC sequences may be based on a hierarchical ZC sequence design, such that each of the considered direct links 121 and indirect links 122 have unique ZC identities. The ZC sequences are designed by the control entity 110 (e.g., a physical or logical entity, and/or a localized or distributed entity).

At the receiver entity 140, the receive signal 205 may be processed to extract the ZC identities of the existing direct links 121 and indirect links 122. The identified links 121, 122 could be optionally further post-processed for different applications (e.g., TA estimation etc.).

The construction of the ZC sequences can be obtained through prior information, which may be fixed or learned. The process of the ZC sequence construction can also be dynamic.

The advantages of the solution of this disclosure include the ability of the receiver entity 140 to identify surrounding active transmitter entities 120 and passive DCS entities 130. Further, the ability of the receiver entity 140 to trace and/or map transmitted signal trajectories. In addition, the solution allows preserving the orthogonality of two or more orthogonal transmission signals, even after these transmission signals respectively experience one or multiple DCS bounces, e.g., the respectively scattered signals have zero or low correlation with each other. The solution enables a systematic way of code construction, which is easy to extend. Moreover, post-processing to derive SINR and/or TA estimations is enabled.

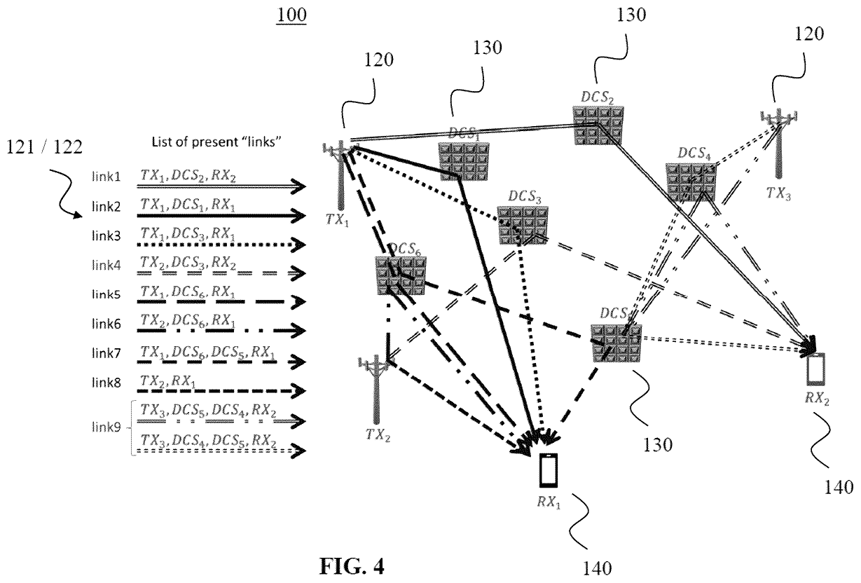

An example of a wireless communication system 100, in which different direct links 121 and indirect links 122 are formed between transmitter entities 120 (“TX”, e.g., BSs) and receiver entities 140 (“RX”, e.g., mobile or terminal devices) via zero or one or more DCS entities 130, is shown in FIG. 4.

As can be seen, each DCS entity 130 comprises a plurality of scattering elements, wherein each scattering element has a controllable phase shift. Each DCS entity 130 may comprise a DCS controller, which is configured to control the scattering of the respectively impinging signal onto the DCS entity 130, by setting a phase shift configuration for the plurality of scattering elements based on the ZC identity configured at the respective DCS entity 130. As described below in more detail, the phase shift configuration can comprise a first phase shift configuration part and a second phase shift configuration part. The DCS controller may in this case be configured to set the first phase shift configuration part as a function of the ZC identity configured at the respective DCS entity 130, and to set the second phase shift configuration part independent of that ZC identity.

In the following some more details and exemplary embodiments of the above-described four steps are described.

In the first step, one may aim to design the ZC identity sets Ωₜₓ, Ω_{dcs}, Ω_{d} and Ω_{b} that specify the ZC identities that could be allocated to the transmitter entities 120, direct links 121, DCS entities 130, and indirect links 122, respectively. Different examples are given below.

In a first example, the design and allocation procedure is based on different properties and conditions that are used jointly for and that could be listed as follows. The length of the ZC sequence is equal to the number of ZC identities that are shared between the direct links 121 and the backscattered links 122:

$${N}_{Z C} = {N}_{d} + {N}_{b} \qquad Eq . 2$$

Different ways could be used to determine these parameters (N_{ZC}, N_{d}, N_{b}). For example, based on the available ZC sequence length and targeted number of ZC identities for transmitter entities 120 identities, one may determine N_{b}. As another example, based on the targeted number of ZC identities for transmitter entities 120 and

$${N}_{b}^{max} ,$$

one may determine the required length of the ZC sequence N_{ZC}.

In order for the backscattered links 122 and the direct links 121 to be uniquely identified, their corresponding ZC identity sets 113, 114 should not have any common element. Thus, the design process of the ZC identity sets 113, 114 should guarantee the two following conditions:

$${Ω}_{d} ⋂ {Ω}_{b} = \{ empty set \} \qquad C . 1$$

$${⋂}_{l = 1}^{γ} {Ω}_{b , l} = \{ empty set \} \qquad C . 2$$

The number of identifiable indirect links 122 is related to the number of considered DCS entities N_{dcs} and the maximum number of supported DCS bounces γ where

$${N}_{b} = {N}_{tx} {\sum }_{l = 1}^{γ} \frac{{N}_{dcs} !}{l ! ( {N}_{d c s} - l ) !} \qquad Eq . 3$$

The DCS reflection process is equivalent to a multiplication process in time domain, where the time domain incident signal 201 (e.g., the transmission signal 204 based on a ZC sequence) is multiplied with the DCS time varying phase shift configuration v(m).

The multiplication of two ZC sequences that have identities uₓ and u_{y} results in another ZC sequence with identity u_{z} being the modular summation of the identities of the two multiplied ZC sequences u_{z}=mod (uₓ+u_{y}, N_{ZC}).

A design example of the identity sets for the case where γ=1 is provided below.

The elements of Ω_{d} (third set 113) are designed so that the N_{ZC} modular distance dₘ between any two adjacent elements is the same (e.g., for N_{ZC}=100, choose Ω_{d}: {1, 11, 21, . . . 91} where dₘ=9). The modular distance dₘ between two elements is defined as the number of elements that lie between the two considered elements within the set 113.

The number of ZC identities to be allocated to the DCS entities N_{dcs} is equal to the designed fixed modular distance between any two adjacent elements of the Ω_{d} set 113. (e.g., with Ω_{d}: {1, 21, . . . , 91} then N_{dcs}=dₘ=9.).

The set Ω_{dcs} (second set 112) is designed so that:
i. The Ω_{dcs} elements are continuous: This means the modular distance between any two adjacent elements of Ω_{dcs} is equal to zero dₘ=0.
ii. The first element in the Ω_{dcs} set is the same as the first element of the Ωₜₓ set (e.g., for N_{ZC}=100 and Ωₜₓ: {1, 11, 21, . . . , 91} then Ω_{dcs}: {1, 2, 3, 4, 5, . . . , 9})
iii. The resulting backscattered links set Ω_{b} is the sets addition (known as Minkowski addition) of ha and Lacs where resulting Ω_{b} will satisfy condition C. 1 (e.g., for N_{ZC}=100, Ω_{d}: {1, 11, 21, . . . , 91} and Ω_{dcs}: {1, 2, 3, 4, 5, . . . , 9} then Ω_{b}: {{2, 3, 4, . . . , 10} u {12, 13, 14, . . . , 20} ∪ . . . ∪ {92, 93, 94, . . . , 100}}.

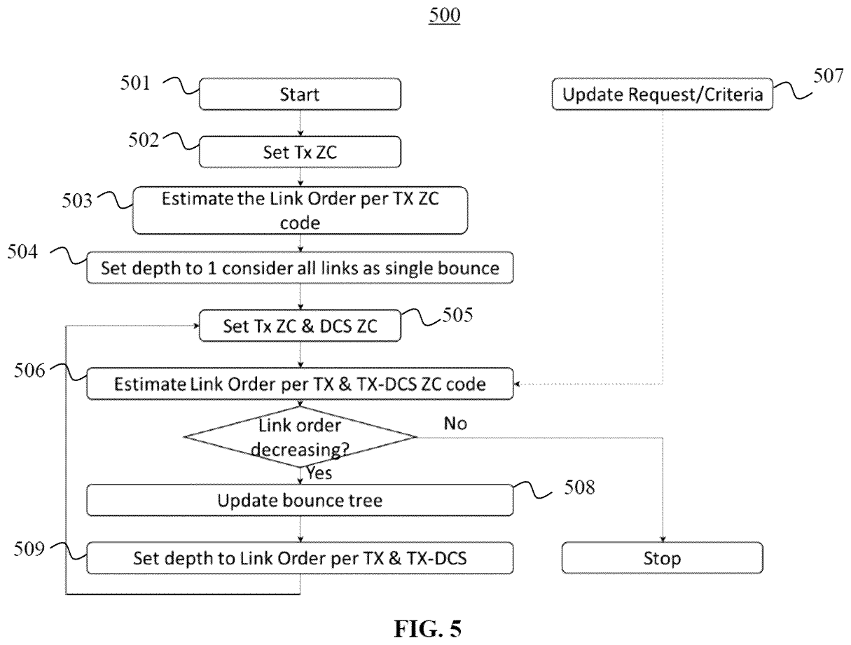

A second example is illustrated in FIG. 5. This is an example of a dynamic construction process of the ZC identity sets, where exploration and exploitation phases are used to identify the structure of present links 121, 122 and their contributors for optimal sequence construction. The process is as follows:

At 501, the process is started. At 502, a ZC identity for each transmitter entity 120 is set (e.g., the ZC length and codes are set) and used to transmit corresponding ZC signal. At 503, a link order (e.g., multipath profile, delay spread, . . . ) is estimated for the observed received signal 205 per transmitter entity ZC code. At 504, the depth γ is set to 1, i.e., only single DCS bounces are considered. At 505, the ZC identities of transmitter entities 120 and DCS entities 130 are set (e.g., the ZC length and codes are updated based on the estimated links' orders). At 506, a link order of the received signal is estimated per transmitter entity ZC code and per transmitter entity to the one or more DCS entities ZC code. Here, update request or criteria set at 507 could be considered. If at least one estimated link order is decreasing, the DCS bounce tree is updated, otherwise the process is ended. After updating the DCS bounce tree, at 509, the depth γ is set based on the estimated link order at 506, and the process returns to 505.

In the second step, the transmitting entity 120 constructs its allocated ZC sequence and modulates it into a baseband waveform to be later transmitted. The k^{th} sample of the N_{ZC} length ZC sequence with uᵢ identity can be written as follows:

$${z}_{{u}_{i}} ( k ) = {e}^{- \frac{j π {u}_{i} k ( k + 1 )}{{N}_{ZC}}}$$

Different baseband modulation techniques could be used by the transmitter entity 120, as long as the baseband transmitted signal preserves the ZC nature (i.e., a ZC sequence with some possible applied scaler and/or frequency shift). Two examples of such modulation techniques that guarantee the preserved ZC nature of the based-band modulated ZC sequence are the OFDM waveform and the CP-OFDM waveform as discussed above.

The third step is about the configuration of the DCS phasor, which is written as a function of two independent phasors:

$$v ( m ) = {e}^{j θ} {e}^{j ϕ ( m )}$$

The DCS common phasor e^{jφ(m)}∈ [symbol] ^{1×1} is designed to transform the incident ZC based signal into another ZC sequence with new ZC identity, so that it could be identified by the receiver entity 140. It should be configured in correspondence with the adopted transmitting technique of the transmitting entity 120. Below, different configurations examples are given, which corresponds to the different transmitting techniques mentioned in the third step above.
a. OFDM incident waveform: The DCS common phasor is designed to imitate a ZC sequence with identity uⱼ and length N_{ZC}

$${e}^{j ϕ ( m )} = {e}^{- \frac{j π {u}_{j} m ( m + 1 )}{{N}_{ZC}}}$$

b. CP-OFDM incident waveform: The DCS common phasor is designed to imitate a cyclic-prefix ZC sequence with identity uⱼ and overall length equal to N_{ZC}+N_{CP}.

$${e}^{j ϕ ( m )} = \{ \begin{matrix}{e}^{- \frac{j π {u}_{j} m ( m + 1 )}{{N}_{ZC}}} & if & {N}_{CP} \leq m < {N}_{ZC} + {N}_{CP} \\ {e}^{- \frac{j π {u}_{j} ( {N}_{ZC} - {N}_{CP} + m ) ( {N}_{ZC} - {N}_{CP} + m + 1 )}{{N}_{ZC}}} & if & 0 \leq m < {N}_{CP}\end{matrix}$$

The DCS element specific phasor e^{θ}∈ [symbol] ^{M×1} may be designed to achieve different objectives, wherein it is independent from the ZC sequence-based common phasor also applied by the DCS. One design example of the DCS element specific phasor e^{jθ} is to be configured to maximize the received signal power at the end-user.

In the fourth step, the receiver entity 140 correlates the overall receive signal 205 with different correlating signals, in order to identify the existing direct links 121 and backscattered links 122.

The generated correlating signal at the receiver entity 140 should account for the frequency shifting the transmitted ZC sequence undergoes due to the OFDM generation process at the transmitter entity 120 and also account for the DCS time varying phase vector which modifies the phase (modulates the phase) of the scattered signal. Thus, one may distinguish two main forms of the received ZC sequence depending on whether it went through a direct link 121 or a backscattered link 122.

Firstly, the arriving frequency shifted ZC sequence via a direct link 121 path has the form:

$$∝ {z}_{{u}_{i}^{- 1}} ( m ) {e}^{- \frac{j 2 π}{{N}_{ZC}} ( 1 - {u}_{i}^{- 1} ) {2}^{- 1} m} \qquad Eq . 4$$

where uᵢ∈Ωₜₓ.

Secondly, the arriving frequency shifted ZC sequence via a backscattered link 122 has the form:

$$∝ {z}_{{u}_{l}} ( m ) {e}^{- \frac{j 2 π}{{N}_{ZC}} ( 1 - {u}_{i}^{- 1} ) {2}^{- 1} m} \qquad Eq . 5$$

where uᵢ∈Ωₜₓ and uₗ∈Ω_{b}.

The receiver entity 140 may generate two sets of correlating signals.

Firstly, the direct link correlating signals, which are based on equation Eq. 4 and they cover all the possible Nₜₓ identities uᵢ∈Ωₜₓ. This results in Nₜₓ correlating signals.

Secondly, the backscattered link correlating signals, which are based on equation Eq. 5 where for each uᵢ∈Ω_{b} they cover all the possible Nₜₓ identities uᵢ∈Ωₜₓ. This results in NₜₓN_{b} correlating signals. The overall number of generated correlating signals at the end-user is equal to Nₜₓ+Nₜₓ N_{b}

The receive signal 205 at the receiver entity 140 might contain different ZC sequences, coming from different transmitting entities 120 after none, one, or multiple bounces by the DCS entities 130. To identify the received direct links 121 and backscattered links 122, the receiver entity 140 correlates the overall receive signal 205 with all pre-generated correlating signals. For each of the correlating signals applied at the receiver 140 to the received signal 205, the output of the correlation process will result in a peak in power when the considered correlating signal matches one of the received direct or backscattered link ZC identity and frequency shift.

In order for the correlation process to function properly and for the receiver entity 140 to generate the needed direct and backscattering links correlating signals, it is beneficially that the receiver entity 140 is provided with prior information about the identity sets 111, 112, 113, and/or 114.

Below, different examples are provided based on different levels of available information at the receiver entity 140.

1. Available information: {N_{ZC}, Ω_{d}, Ω_{b}}
i. Based on this knowledge the receiver entity 140 can generate correctly the direct and the backscattered links correlating signals.
ii. This allows the receiver entity 140 to possibly identify the existing direct and backscattered links 121, 122 within its receive signal 205.
iii. The receiver entity 140 will be capable distinguishing between a detected direct link 121 and a detected backscattered link 122.
iv. The receiver entity 140 cannot distinguish the backscattered links 122 that have different number of DCS bounces.

2. Available information: {N_{ZC}, Ωₜₓ, Ω_{dcs}, γ}
a. Same a, b, c of previous example.
b. The knowledge of the Ω_{dcs} set and γ parameter gives the receiver entity 140 a visibility of how to construct the Ω_{b} set. This knowledge allows the receiver entity 140 to distinguish between the backscattered links 122 that have different number of DCS bounces.

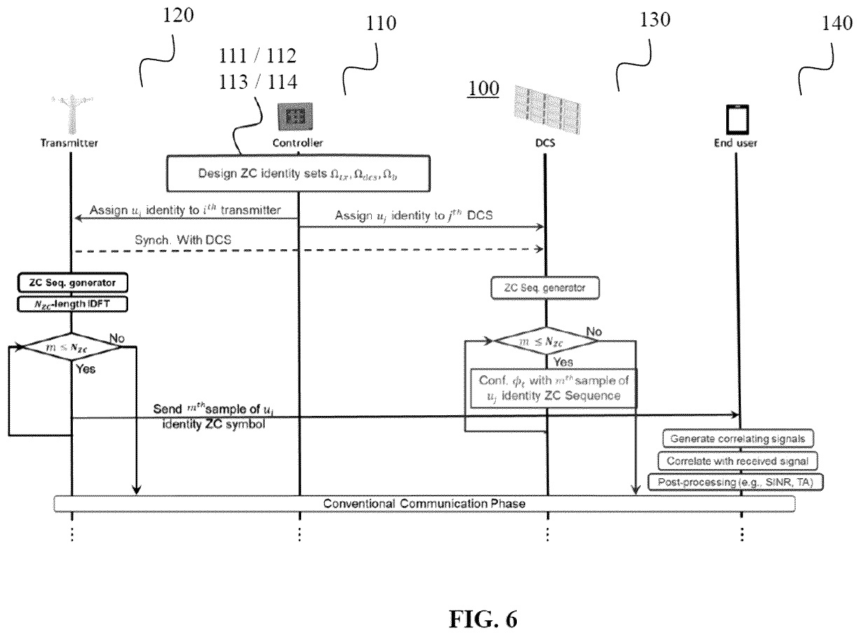

FIG. 6 shows an exemplary embodiment of a wireless communication system 100 according to this disclosure. A signaling example is provided, wherein the i^{th} transmitter entity 120 and the j^{th} DCS entity 130 are allocated the uᵢ and uⱼ ZC identities, respectively. The ZC identities are used by each entity to construct its ZC sequence in a synchronized manner, in order to result in a ZC based signal at the receiver entity 140 with a new ZC identity that the receiver entity 140 could extract via correlation and later user in different post processing.

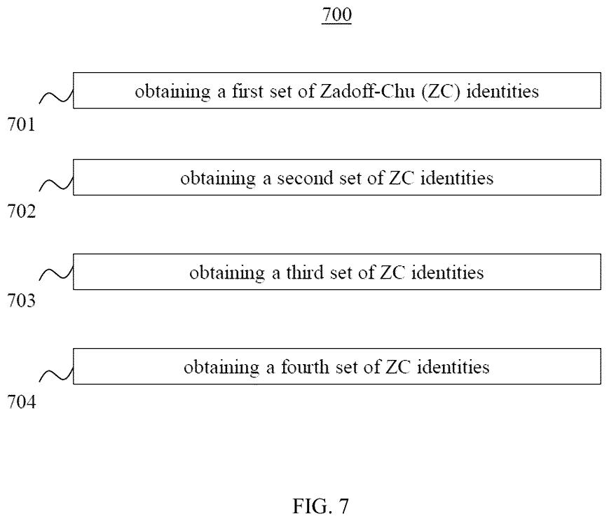

FIG. 7 shows a method 700 according to an embodiment of this disclosure, which is performed by the control entity 110. The method 700 comprises one or more of the following steps 701, 702, 703, and 704. A step 701 of obtaining a first set 111 ZC identities, wherein the ZC identities of the first set 111 are designed for being individually allocated to one or more transmitter entities 120 in the wireless communication system 100. A step 702 of obtaining a second set 112 of ZC identities, wherein the ZC identities of the second set 112 are designed for being individually allocated to one or more DCS entities 130 in the wireless communication system 100. A step 703 of obtaining a third set 113 of ZC identities, wherein each ZC identity of the third set 113 is associated with a different direct link 121 from one of the one or more transmitter entities 120 to a receiver entity 140 in the wireless communication system 100 than the other ZC identities of the third set 113. A step 704 of obtaining a fourth set 114 of ZC identities, wherein each ZC identity of the fourth set 114 is associated with a different indirect link 122 from one of the one or more transmitter entities 120 via at least one of the one or more DCS entities 130 to the receiver entity 140 than the other ZC entities of the fourth set 114. The ZC identities of the third set 113 are related according to a one-to-one function to the ZC identities of the first set 111, for example, the ZC identities of the first set 111 may be respective inverses of the ZC identities of the third set 113. Each ZC identity is configured to determine a unique ZC sequence, i.e., two ZC identities related to two distinct ZC sequences. The third set 113 and the fourth set 114 have no ZC identity in common.

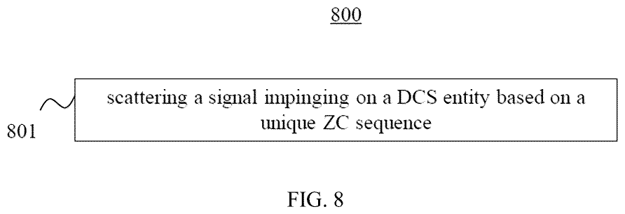

FIG. 8 shows a method 800 according to this disclosure, which is performed by a DCS entity 130. The method 800 comprises a step 801 of scattering a signal 201 impinging on the DCS entity 130. The scattering step 801 is based on a unique ZC sequence that is determined by a ZC identity 202, with which the DCS entity 130 is configured.

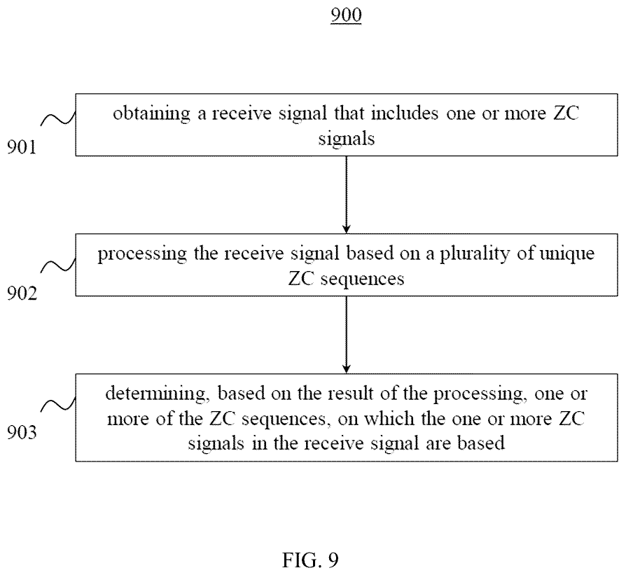

FIG. 9 shows a method 900 according to this disclosure, which is performed by a receiver entity 140. The method 900 comprises a step 901 of obtaining a receive signal 205 that includes one or more ZC signals 203, 204, 207, which are respectively based on one or more transmission signals respectively originating from one or more transmitter entities 120 and respectively scattered by zero or one or more DCS entities 130 in a wireless communication system 100. Further, the method 900 comprises a step 902 of processing the receive signal 205 based on a plurality of unique ZC sequences that are respectively determined by a plurality of ZC identities 206, with which the receiver entity 140 is provided. Then, the method 900 comprises a step 903 of determining, based on the result of the processing, one or more of the ZC sequences, on which the one or more ZC signals 203, 204, 207 in the receive signal 205 are based.

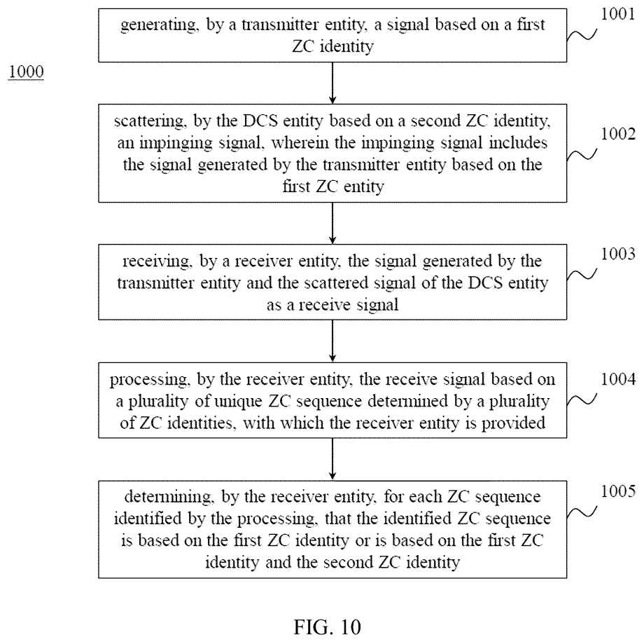

FIG. 10 shows a method 1000 according to this disclosure, which is performed by a wireless communication system 100. The wireless communication system 100 comprises at least a transmitter entity 120, a receiver entity 140, and a DCS entity 130, which perform the method 1000. The transmitter entity 120 is provided with a first ZC identity 123, the DCS entity 130 with a second ZC identity 202, and the receiver entity 140 with a plurality of ZC identities 206. The method 1000 comprises a step 1001 of generating, by the transmitter entity 120, a signal 204 based on the first ZC identity 123, wherein the signal is based on a unique ZC sequence determined by the first ZC identity 123. The method 1000 further comprises a step 1002 of scattering, by the DCS entity 130 based on the second ZC identity 202, an impinging signal 201, wherein the impinging signal 201 includes the signal 204 generated by the transmitter entity 120 based on the first ZC identity 123, and wherein the scattered signal 201s, 203 includes a signal containing a unique ZC sequence that is based on the first ZC identity 123 and the second ZC identity 202.

The method 1000 further comprises a step 1003 of receiving, by the receiver entity 140, the signal 204 generated by the transmitter entity 120 and the scattered signal 203 of the DCS entity 130 as a receive signal 205. The method 1000 then comprises a step 1004 of processing, by the receiver entity 140, the receive signal 205 based on a plurality of unique ZC sequence determined by the plurality of ZC identities 206, with which the receiver entity 140 is provided. Finally, the method 1000 comprises a step 1005 of determining, by the receiver entity 140, for each ZC sequence identified by the processing, that the identified ZC sequence is based on the first ZC identity 123 or is based on the first ZC identity 123 and the second ZC identity 202.

The present disclosure has been described in conjunction with various embodiments as examples as well as implementations. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A method implemented by a control entity or and comprising:
enabling identification of one or more digitally controllable scattering (DCS) entities by:
obtaining a first set of first Zadoff-Chu (ZC), identities, a second set of second ZC identities a third set of third ZC identities and a fourth set of fourth ZC identities, wherein the first ZC identities of the are designed for being individually allocated to one or more transmitter entities, wherein the second ZC identities are designed for being individually allocated to the one or more DCS entities; wherein the third ZC identities are associated with different direct links from the transmitter entities to a receiver entity, wherein the third ZC identities are related according to a one-to-one function to the first ZC identities, wherein the fourth ZC identities are associated with different indirect links from the transmitter entities to the receiver entity via the DCS entities, wherein the first ZC identities, the second ZC identities, the third ZC identities, and the fourth ZC identities determine unique ZC sequences, and wherein the third set and the fourth set have no ZC identity in common;
signaling the first set or the third set to the one or more transmitter entities;
signaling the second set to the one or more DCS entities;
signaling the first set of the third set to the receiver entity; and
signaling the second set or the fourth set to the receiver entity.

2. The method of claim 1, wherein the fourth set comprises one or more subsets of the fourth ZC identities, wherein each of the fourth ZC identities of each respective subset is associated with an indirect link from one of the one or more transmitter entities via a respective number of the one or more DCS entities to the receiver entity, and wherein the respective number is different for different subsets.

3. The method of claim 1, wherein obtaining the first set, the second set, the third set, and the fourth set comprises constructing the first set, the second set, the third set, and the fourth set, respectively.

4. The method of claim 1, further comprising:
signaling a different first ZC identity of the first ZC identities to each of the transmitter entities or signaling a different third ZC identity of the third ZC identities to each of the one or more transmitter entities; and
signaling a different second ZC identity of the second ZC identities to each of the one or more DCS entities.

5. The method of claim 1, wherein signaling to the receiver entity comprises signaling the third set and the fourth set to the receiver entity.

6. The method of claim 2, further comprising signaling the number of subsets in the fourth set to the receiver entity.

7. The method of claim 1, further comprising signaling a ZC sequence length to the receiver entity, wherein the ZC sequence length is the same for each unique ZC sequence.

8. A method implemented by a digitally controllable scattering (DCS) entity and comprising:
receiving a Zadoff-Cho (ZC) identity assigned to the DCS entity;
determining a unique ZC sequence based on the ZC identity;
receiving a signal impinging on the DCS entity;
scattering, based on the unique ZC sequence the signal to produce a scattered signal, and
transmitting the scattered signal.

9. The method of claim 8, wherein the signal comprises one or more ZC signals that are respectively based on one or more transmission signals originating from one or more transmitter entities, wherein the one or more ZC signals comprise one or more ZC sequences, and wherein the one or more transmission signals are not scattered or are scattered by one or more other DCS entities.

10. The method of claim 8, wherein the DCS entity comprises a plurality of scattering elements having controllable phase shifts, and wherein the method further comprises controlling the scattering of the signal by setting phase shift configurations for the scattering elements based on the ZC identity.

11. The method of claim 10, wherein the phase shift configurations comprise a first phase shift configuration part and a second phase shift configuration part, and wherein the method further comprises:
setting the first phase shift configuration part as a function of the ZC identity; and
setting the second phase shift configuration part independent of the ZC identity.

12. The method of claim 8, wherein receiving the ZC identity comprises receiving, from a control entity, a signal comprising the ZC identity.

13. The method of claim 9, wherein the scattered signal is based on the one or more ZC sequences and the unique ZC sequence.

14. A method implemented by a receiver entity and comprising:
obtaining a receive signal comprising one or more ZC signals that are based on one or more transmission signals originating from one or more transmitter entities, wherein the one or more transmission signals are not scattered or are scattered by zero or one or more DCS entities;
generating a plurality of unique ZC sequences from a plurality of ZC identities of the receiver entity;
processing the receive signal based on the plurality of unique ZC sequences to obtain a processing result; and
determining, based on the processing result, one or more of the ZC sequences,
wherein the one or more ZC signals are associated with the one or more of the ZC sequences.

15. The method of claim 14, wherein processing the receive signal comprises correlating the receive signal with each of a plurality of correlating signals, wherein each of the correlating signals is based on one of the unique ZC sequences.

16. The method of claim 14, further comprising determining, for each of the one or more ZC sequences, based on the plurality of ZC identities, the one or more transmitter entities from which the one or more ZC sequences originated or the one or more DCS entities via which the ZC sequences propagated.

17. The method of claim 15, further comprising generating the plurality of correlating signals based on the plurality of ZC identities.

18. The method of claim 14, wherein the plurality of ZC identities comprises at least one of:
a first set of first ZC identities, wherein each of the one or more transmitter entities is configured with one of the first ZC identities;
a second set of second ZC identities, wherein each of the one or more DCS entities is configured with one of the second ZC identities;
a third set of third ZC identities, wherein each direct link from one of the one or more transmitter entities to the receiver entity is associated with one of the third ZC identities; or
a fourth set of fourth ZC identities, wherein each indirect link from one of the one or more transmitter entities and via at least one of the one or more DCS entities to the receiver entity is associated with one of the fourth ZC identities.

19. The method of claim 18, further comprising receiving a signaling from a control entity, wherein the signaling comprises the first set or the third set and comprises the second set or the fourth set.

20. The method of claim 14, further comprising determining a timing advance based on the one or more ZC sequences or based on information identifying: (i) which of the one or more transmitter entities transmitted the one or more transmission signals corresponding to the one or more ZC signals; and (ii) which of the one or more DCS entities scattered the one or more transmission signals.
